(19) United States
(12) Patent Application Publication
(10) Pub. No.: US 2015/0339261 A1
(43) Pub. Date: Nov. 26, 2015

(54) SYSTEM AND METHOD FOR DATA TRANSFER AMONG THE DEVICES

(71) Applicant: SAMSUNG ELECTRONICS CO., LTD., Suwon-si (KR)

(72) Inventors: Ashish Kumar JHA, Noida (IN); Santhanasamy AROCKIYASAMY, Tirunelveli (IN)

(73) Assignee: SAMSUNG ELECTRONICS CO., LTD., Suwon-si (KR)

(21) Appl. No.: 14/717,001

(22) Filed: May 20, 2015

(30) Foreign Application Priority Data
May 23, 2014 (IN) 1381/DEL/2014

(51) Int. Cl. G06F 15/173

(52) U.S. Cl. CPC G06F 15/17325

(57) ABSTRACT

Methods and systems for dynamically synchronizing a data item between at least one first device and at least one second device are provided. The method includes identifying a change in the at least one data item in the at least one first device, where each of the at least one data item can be associated with the at least one second device. Further, the method includes creating a data set including the changed at least one data item separately for each of the at least one second device associated with the at least one changed data item, and transferring the data set to the at least one second device without receiving any request message from the at least second device.

### CROSS-REFERENCE TO RELATED APPLICATION(S)

This application claims priority from of Indian Provisional Patent Application No. 1381/DEL/2014 filed on May 23, 2014 in the Indian Intellectual Property Office and an Indian Non-Provisional Patent Application No. 1381/DEL/2014 filed on Sep. 11, 2014 in the Indian Intellectual Property Office, the disclosures of which are hereby incorporated by reference in their entireties.

### BACKGROUND

1. Field

Apparatus, systems and methods consistent with exemplary embodiments described herein generally relate to synchronization systems, and more particularly to a mechanism for automatically synchronizing respective data items between a first device and a second device dynamically in real-time with minimum possible delay.

2. Description of the Related Art

Users of communication or data devices are increasingly accessing common data on many of the devices they use. For example, a user may use a smart phone, a tablet, a smart watch, a smart television, smart glasses, and the like to manage various applications such as emails, calls, calendar, personal and business contacts, and electronic documents, media files, and the like. Generally, most of such devices have their own independent databases that store the information about the respective applications. Increasingly, people may own or use several such devices and have the need to maintain and update current information on all such devices.

Related art techniques for synchronizing data on the devices involve synchronization between a first and a second device. The respective applications of the second device are fetched from the first device only after receiving a request for synchronization from the second device. Upon receiving the request for synchronization from the second device, a data set will be prepared and transferred by the first device. Thus, it is not possible to have a real-time synchronization using the approaches described above as the second device does not know on its own if it needs to update itself such that the second device can send the request to the first device. Moreover, a peer (i.e. first device) can send real-time common data to all of its connected second devices. If there is a change in the application data in the first device, a single common data set will be prepared and can be sent to all of the connected second devices. The related art systems described herein are unable to create and send the device specific separate data sets.

Further, it is possible to have a first device to be a data provider for multiple applications and for each application it may have to be the data provider of multiple and optionally different second devices. It may be a common situation in which for an application, a data provider device may need to transfer different data sets for each of its dependent devices. To facilitate the real-time transfer for an application data provider, there must be minimal data preparation time of the data sets for each of the dependent devices. Hence, the data provider device may need to store the different data sets for an application, which may be needed to be sent to each of its different dependent devices so as to obviate the data preparation time.

Thus, there remains a need for a fast and efficient mechanism to facilitate the real-time reflection of changes in a first device to its second devices. There also a need for a mechanism for maintaining the correct and consistent state of devices in case when any of the paired device for an application or set of applications, are added or removed, so as to enable the correct state of synchronization of an application data.

### SUMMARY

According to an aspect of an exemplary embodiment, there is provided a method for dynamically synchronizing a data item between at least one first device and at least one second device, the method including identifying a change in the at least one data item in the at least one first device, wherein each of the at least one data item is associated with the at least one second device; creating at least one data set including the at least one data item that is changed for each of the at least one second device associated with the at least one data item that is changed; and transferring the at least one data set to the at least one second device associated with the at least one data item that is changed prior to receiving a request for synchronization from the at least one second device.

According to an aspect of another exemplary embodiment, there is provided a first device for dynamically synchronizing with a data item in at least one second device, the first devices including a processor comprising a controller module configured to identify a change in the at least one data item in the first device, wherein each of the at least one data item is associated with the at least one second device, and a data configuration module configured to create at least one data set including the at least one data item that is changed for each of the at least one second device associated with the at least one data item that is changed; and a communicator configured to transfer the at least one data set to the at least one second device associated with the at least one data item that is changed prior to receiving a request for synchronization from the at least one second device.

One or more exemplary embodiments herein provides a system and method to efficiently handle a connection change in one or more first devices and one or more second devices, initial setups between the first device and the second device, and maintain a state of one or more first devices with one or more second devices in case when any of the second device for an data item or set of data items can be added or removed so as to enable the correct state of synchronization of the data item. A controller module in the first device can be configured to track one or more second devices and the data items corresponding to each second device. Further, the controller module can be configured to determine if there is any new device connected to the first device requesting initial synchronization for the specific set of data items. Further, the controller module can create an entry for the new device for the requested data item in the first device. Further, the controller module can keep the record of data already sent to the second device. In first device, the controller module can maintain the real time separate data set including the changed data item associated with the specific second device for sending the data set including changed data item as soon as the connection is available between the first device and the second device. Further, if the controller module receives any updated data set for the data item or the set of data items in case of an explicit user un-pairing operation in the second device, the controller module can remove all the corresponding data sets. If the update operation is initiated in the second device, then in the first device, once the data is removed a complete acknowledgement for the same can be sent to the second device. The second device can drop all the incoming data sets corresponding to the updated data item set until it receives acknowledgment for the same from the first device.

One or more exemplary embodiments provide a computer readable medium including a computer executable program code recorded on a computer readable non-transitory storage medium for dynamically synchronizing data between one or more first devices and one or more second devices. Further, the computer executable program code when executed causing the actions including identifying a change in at least one data item in at least one first device, wherein each data item is associated with at least one second device; creating at least one data set including the at least one data item that is changed for each second device associated with the at least one data item that is changed; and transferring the at least one data set to the at least one second device associated with the at least one data item that is changed prior to receiving a request for synchronization from the at least one second device.

These and other aspects of the exemplary embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Aspects of the exemplary embodiments are illustrated in the accompanying drawings, throughout which like reference letters indicate corresponding parts in the various figures. The exemplary embodiments will be better understood from the following description with reference to the drawings, in which:

FIG. 1 illustrates a high level overview of a system for dynamically synchronizing a data item between one or more first devices and one or more second devices, according to an exemplary embodiment;

FIG. 2 illustrates various modules available in one or more first devices, according to an exemplary embodiment;

FIG. 3 illustrates various modules available in one or more second devices, according to exemplary embodiments;

FIG. 4 illustrates various operations performed between one or more first devices and one or more second devices, according to an exemplary embodiment;

FIGS. 5A through 5F illustrate example system block diagrams for dynamically synchronizing separate data items between one or more first devices and one or more second devices, according to exemplary embodiments;

FIG. 6 is a flow diagram illustrating a method for maintaining the correct and consistent state of a second device, according to exemplary embodiments;

FIG. 7 is a flow diagram illustrating a method for first time synchronization of data item between one or more first and second devices, according to exemplary embodiments;

FIG. 8 is a flow diagram illustrating a method for updating data items in response to detecting a change in configuration of a data item associated with a second device, according to an exemplary embodiment;

FIG. 9 is a flow diagram illustrating a method for maintaining the correct and consistent state of a first device, according to an exemplary embodiment;

FIG. 10 is a flow diagram illustrating a method for effectively managing data items in the first and second devices, according to an exemplary embodiment;

FIG. 11 is a flow diagram illustrating a method for dynamically synchronizing a data item between one or more first devices and one or more second devices, according to an exemplary embodiment;

FIGS. 12A through 12J illustrate examples of a Graphical User Interface (GUI) on a first device or a second device for selecting one or more first devices or one or more second devices, and data items, according to exemplary embodiments; and

FIG. 13 illustrates a computing environment implementing the method and system for automatically synchronizing a data item between one or more first devices and one or more second devices, according to an exemplary embodiment.

### DETAILED DESCRIPTION

Exemplary embodiments will be described more fully with reference to the accompanying drawings. Descriptions of well-known components and processing techniques are omitted so as to not unnecessarily obscure the embodiments herein. Also, the various exemplary embodiments described herein are not necessarily mutually exclusive, as some embodiments can be combined with one or more other embodiments to form new embodiments. The term “or” as used herein, refers to a non-exclusive or, unless otherwise indicated. Expressions such as “at least one of,” when preceding a list of elements, modify the entire list of elements and do not modify the individual elements of the list. The examples used herein are intended merely to facilitate an understanding of ways in which the embodiments herein can be practiced and to further enable those skilled in the art to practice the embodiments herein. Accordingly, the examples should not be construed as limiting the scope of the exemplary embodiments herein.

Exemplary embodiments provide a system and method for dynamically synchronizing a data item between one or more first devices and one or more second devices. The method includes identifying a change in the data item in one or more first devices, where each data item is associated with one or more second devices. Further, the method includes dynamically creating a data set including the changed data item for each of the second device associated with the changed data item. Unlike conventional systems, separate data sets can be created by the first device for each of the dependent second devices as and when a change in the data items is detected.

Furthermore, the method includes transferring the data set to one or more second devices dynamically in real time with minimum possible delay. The system and method can be used to facilitate real-time data transfer between the first and second devices. Unlike related art systems, where the second device needs to send a request to receive the updated data item in the first device, the proposed system and method can be used to automatically create separate data sets specific to individual second device and transfer dynamically in real time with minimum possible delay. Fast access to update the changed data item in the first device for each second device associated with the changed data item can be achieved without sending any request message from the second device.

In related art systems, it is not possible to have a real-time synchronization using request/response approaches as the second device is not capable of knowing on its own if it needs to update itself and thus request the first device. Further, the data set including the changed data item can be sent instantaneously as soon as there is a connection between the first device and the second device, using the already prepared data set including the changed data item, without including any data preparation or request processing delay.

Each first device can be a parent for a different set of applications for its every second device and each second device may have different and multiple data providers for each of its applications. For each second device, application specific different data sets are created and transferred to the respective second devices in real-time, without waiting for the request. If there is a connection with the corresponding second devices, then the data sets are instantly sent to the corresponding connected second device as soon as it is created. If the connection is not present between the first device and second device corresponding to the changed data sets, then these data sets are sent as soon as there is the connection between them dynamically, without waiting for any request. Further, systems and methods according to exemplary embodiments can be used to efficiently handle the changing connections, initial setups, and maintaining state of multiple first devices with multiple second devices, in case when any of the paired device for an application or set of applications, are added or removed, so as to enable the correct state of sync of an application data. Furthermore, systems and methods according to exemplary embodiments can be implemented using existing infrastructure and may not require extensive setup and instrumentation.

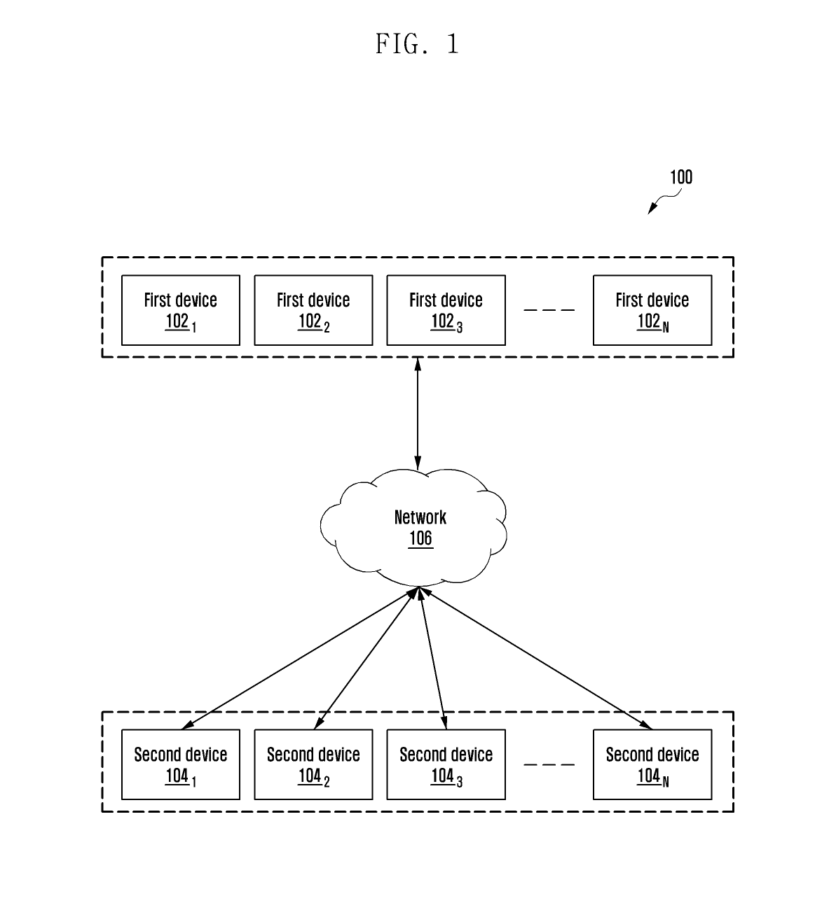

Referring now to the drawings, and more particularly to FIGS. 1 through 13, where same reference characters denote corresponding features that appear in different drawings, description of exemplary embodiments is provided.

FIG. 1 illustrates a high level overview of a system 100 for dynamically synchronizing a data item between one or more first devices 102_{1-N} (hereafter referred as FD 102) and one or more second devices 104_{1-N} (hereafter referred as SD 104) communicating among each other using a network 106, according to an exemplary embodiment.

In an exemplary embodiment, the FD 102 can be a parent device or master device such as for example, but not limited to, a laptop, a desktop computer, a mobile phone, a smart phone, a Personal Digital Assistant (PDA), a tablet, a phablet, a consumer electronic device, a server, or any other electronic device. The SD 104 described herein can be a slave device or dependent device for example, but not limited to, a smart watch, smart glasses, a smart band, eyewear, and the like. In an exemplary embodiment, the FD 102 can be selected from a group of eligible devices along with the other devices acting in the role of slave or dependent devices by being paired with the eligible device that acts in the role of master or primary device.

The FD 102 can include appropriate interfaces to directly or indirectly communicate with the SD 104 and with various other devices over the network 106. The network 106 described herein can be for example, but not limited to, wireless network, wire line network, public network such as the Internet, private network, global system for mobile communication network (GSM) network, general packet radio network (GPRS), local area network (LAN), wide area network (WAN), metropolitan area network (MAN), cellular network, public switched telephone network (PSTN), personal area network, Bluetooth, Wi-Fi Direct, Near Field communication, Ultra Wide band, a combination thereof, or any other network.

Each of the FD 102 and the SD 104 can include a plurality of data items such as for example, but not limited to, a contact data item, a gallery data item, a music data item, a reminder data item, an email message data item, a document data item, a social networking site (SNS) data item, and the like. Each data item can have its own database containing the relevant data item set in it. A memory table consisting of relevant data in the database can be present. Not all the devices necessarily need to process all kinds of the data items. For example, a first SD (SD1) can be configured to process the calendar data item associated with a first FD (FD1), the email message data item, the contact data item, and the document data item. As another example, a second SD (SD2) can be configured to process the calendar data item and the gallery data item associated with the first FD (FD1) and a second FD (FD2).

To enable a user to process the same underlying information associated with each data item (e.g., information embodied in specific data items), the information can be synchronized between devices. Synchronizing data items between two different devices can include, for example, initially paring one or more FD 102 with one or more SD 104 and then automatically synchronizing the information associated with the corresponding data items among the devices.

Subsequent to the initially pairing and the synchronization, the FD 102 can be configured to identify a change in their data items and dynamically transfer the changed data set to automatically synchronize the changed data item in the FD 102 with the data items of the corresponding paired SD 104. The synchronization of two data items can include updating one or both of the data items to reflect changes in either of the data item since an initial or previous synchronization. For example, if contact data elements are synchronized between an FD₁ and an SD₁, and one of the contacts is subsequently modified in the FD₁ then synchronizing the contacts can include applying the same modification to the corresponding contact in the SD₁.

The FD 102 can be configured to dynamically create a data set including the changed data item for each of the SD 104 associated with the changed data item. Unlike conventional systems, separate data sets can be created for each SD 104 associated with the changed data item. Further, the FD 102 can be configured to transfer the created separate data sets to the SD 104, dynamically in real time with minimum possible delay, from the SD 104. Unlike related art systems, where a second device would need to send a request for synchronization to receive the updated data item in a corresponding first device, according to exemplary embodiments separate data sets specific to the individual SD 104 can be automatically created and transferred to it, dynamically in real time with minimum possible delay, from the SD 104. Fast access to update the changed data item in the FD 102 for each SD 104 associated with the changed data item can be achieved without sending any request message from the SD 104.

Although the FIG. 1 shows a limited number of devices including the FD 102, and the SD 104 coupled to the network 106, it is understood that other exemplary embodiments are not limited thereto. The system 100 is only one example of a suitable environment and is not intended to suggest any limitation on scope or functionality of other exemplary embodiments. Further, the system 100 can include different modules communicating among each other along with other hardware or software components. For example, the component can be, but not limited to, a process running in the first or second devices, an executable process, a thread of execution, a program, or a computer. By way of illustration, both an application running on an electronic device and the electronic device can be the component.

Further, the labels such as “first,” “second,” are used merely to differentiate the electronic devices and do not limit the scope of the exemplary embodiments.

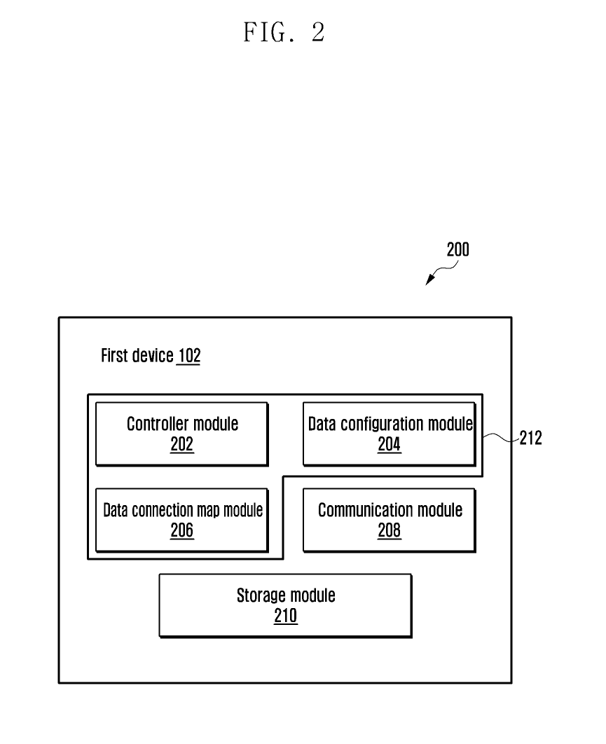

FIG. 2 illustrates various modules 200 available in the FD 102, according to an exemplary embodiment. In an exemplary embodiment, the FD 102 may include a controller module 202, a data configuration module 204, a data connection map module 206, a communicator 208, and a storage 210. Further, in an exemplary embodiment the controller module 202, data configuration module 204, and data connection map module 206 may be implemented by a processor 212.

Further, the controller module 202 can be configured to receive initial set-up request from the SD 104 requesting the FD 102 to be the data provider for the set of data items present in the FD 102. Further, the communication module 208 can be configured to fetch information from the request message and can create the entry for the SD 104 in the data configuration module 204. Further, the controller module 202 can be configured to connect the SD 104 and maintain a state of the FD 102 with the SD 104. Further, the controller module 202 can be configured to determine whether there is any change in the data items in the FD 102.

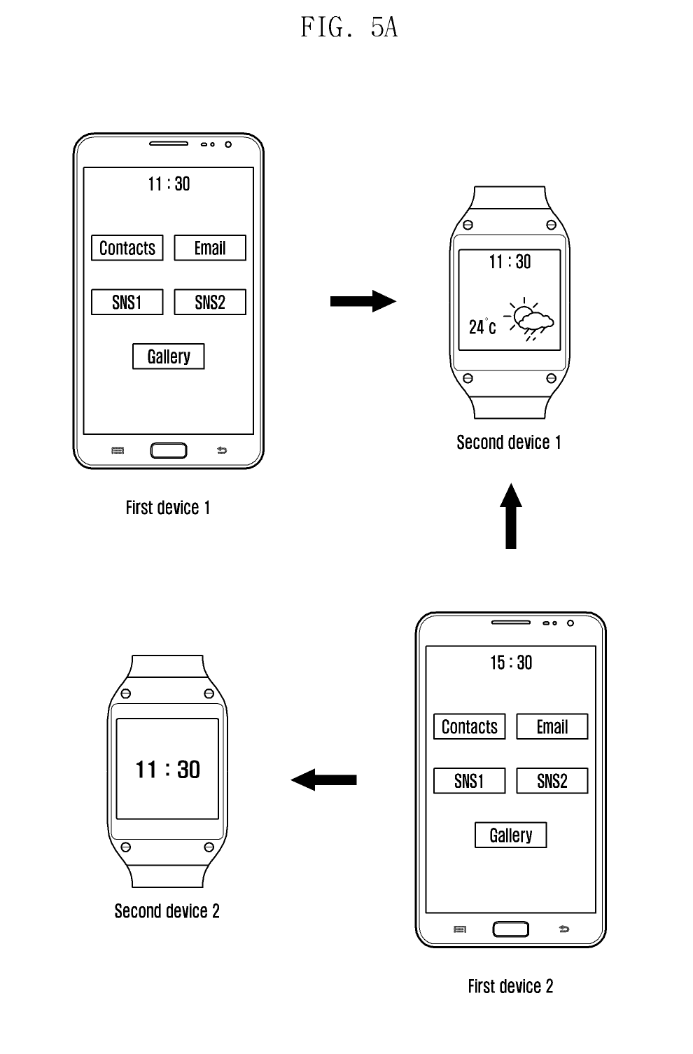

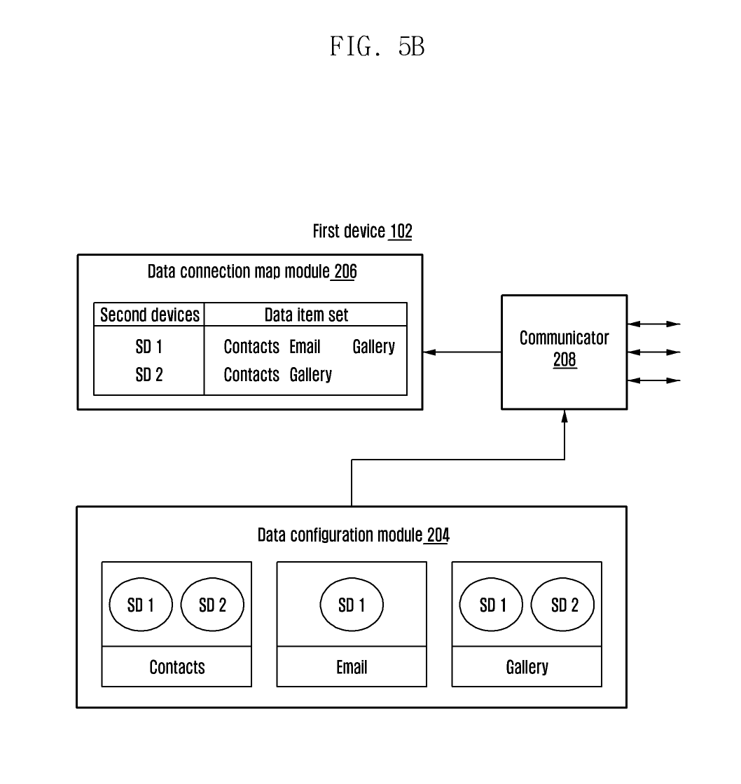

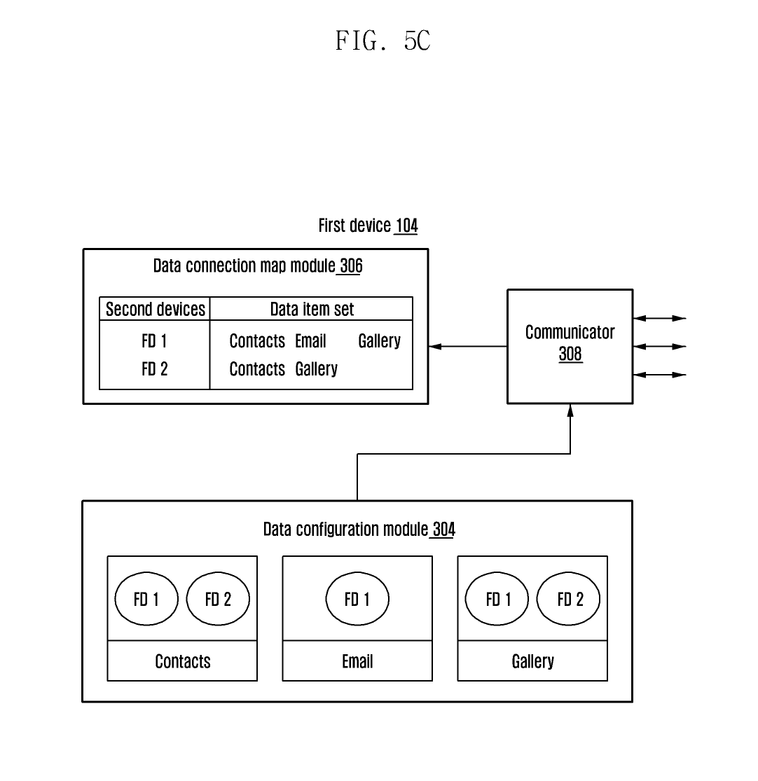

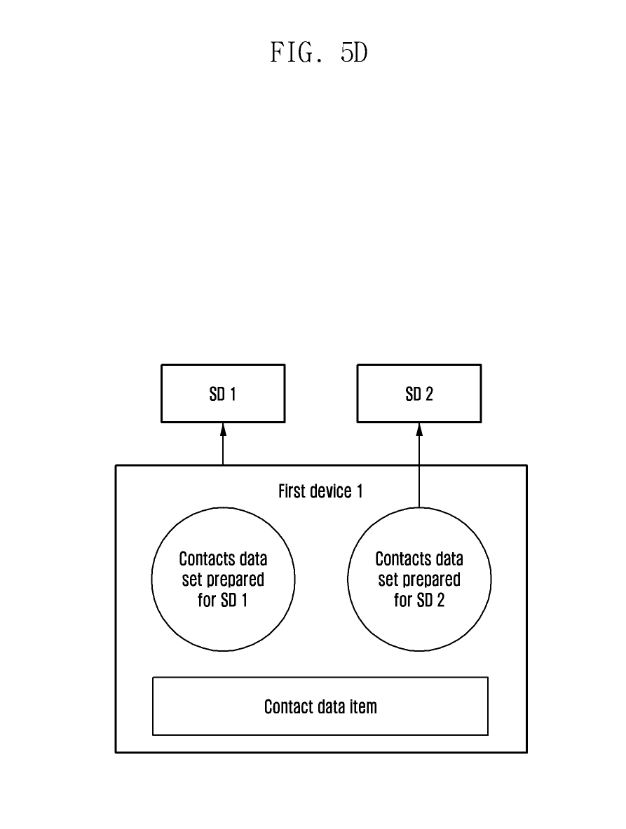

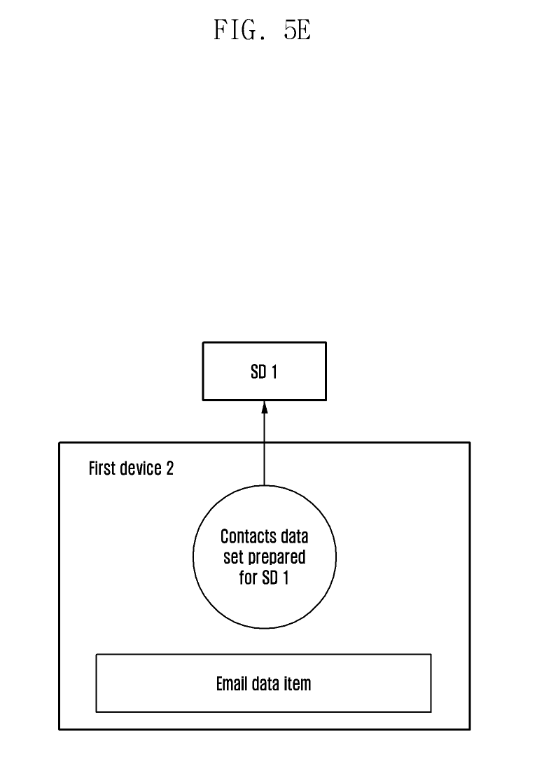

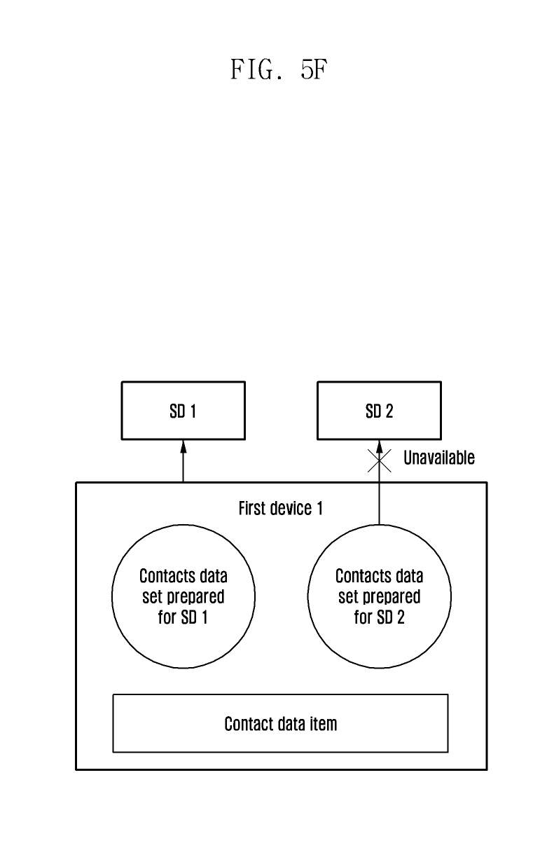

In an exemplary embodiment, the data configuration module 204 can be configured to prepare separate data sets including the changed data item for all of the SD 104. For example, for the change in the gallery data item, the separate data sets are needed to be transferred for the SD₁ and SD₂ (Refer FIG. 5B).

In an exemplary embodiment, the data connection map module 206 can be configured to maintain the mapping between each of the SD 104 connected to the FD 102 with their dependent data items as shown in FIG. 5B. For example, consider the FD 102 which has two entries for the SD 104 (i.e. SD₁, and SD₂). Here, the SD₁ can be dependent on the FD 102 for a contact data item, an email data item, and a gallery data item. Also, the SD₂ can be dependent on the FD 102 for the contacts data item, and the gallery data item whereas, SD₃ can be dependent on the FD 102 for the gallery data item (Refer FIG. 5B). This signifies that for the SD₁, the FD 102 needs to prepare separate data sets for the contact data item, email data item and gallery data item. For SD₂, the FD 102 needs to prepare separate data sets for the contact data item, and gallery data item. For SD₃, the FD 102 needs to prepare separate data sets for the gallery data item.

Further, the data configuration module 204 can be configured to dynamically prepare a separate copy of the actual data set for each of the SD 104. Each separate data copy can be transferred to the respective SD 104 without waiting for any request message from the SD 104.

Further, the communicator 208 can be configured to transfer the separate copy of the data set to the SD 104, without waiting for any request. The data set can be sent instantaneously as soon as there is a connection between the FD 102 and the SD 104, using the already prepared data set associated with the changed data item, without including any data preparation or request processing delay. Further, the controller module 202 can be configured to maintain the separate data sets for each of the SD 104. In an exemplary embodiment, the communicator 208 can be configured to send and receive the data set from the SD 104. Whenever there is a change in the data item in the FD 102, the SD 104 associated with the changed data item can be identified. Based on the identified SD 104, the separate data sets can be prepared corresponding to the changed data item and with respect to the synchronization state of each SD 104. Further, the communication module 208 can be configured to detect if there is a connection available with the SD 104 at that instant in time, then the data set including the changed data item can be sent instantaneously to the SD 104.

Further, the controller module 202 can be configured to determine if there is any new SD 104 that is connected to the FD 102 and requesting an initial synchronization for the specific or set of data items in the FD 102. The controller module 202 can be configured to create an entry for the SD 104 for the requested data item and can mark the new SD 104 as SD 104. The data connection map module 206 can be configured to receive request messages from the controller module 202 to add an entry for the new SD 104. Further, the data connection map module 206 can be configured to notify the data configuration module 204 to prepare the data sets for the SD 104 for the requested data items in the FD 102. Moreover, the FD 102 can keep a record of the data already sent to the SD 104 and consider the information while preparing the data set for the SD 104. The FD 102 can maintain the real-time data set including the changed data item exclusively for the SD 104 for sending the data set to the SD 104.

Furthermore, the storage 210 can be configured to store various data items, data sets, information about the SD 104, and the like. The storage 210 can be configured to store control instructions to perform various operation in the system 100.

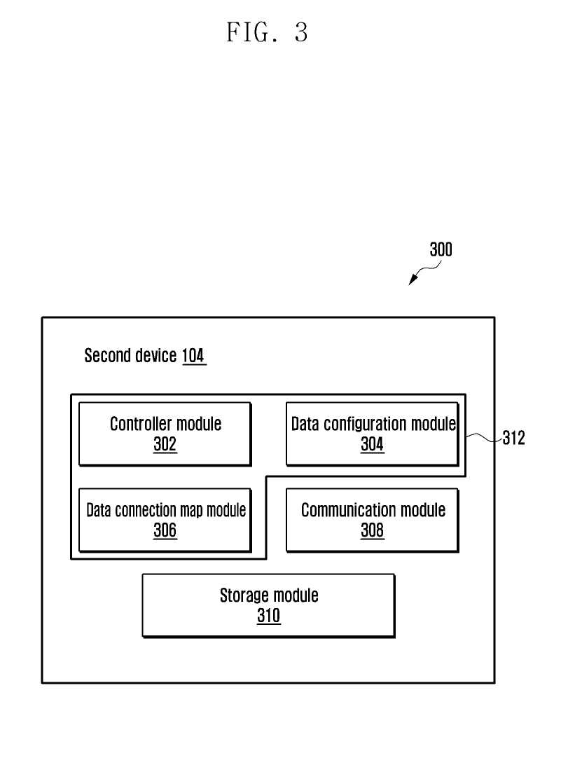

FIG. 3 illustrates various modules 300 available in the second device, according to an exemplary embodiment. In an exemplary embodiment, the SD 104 can be configured to include a controller module 302, a data configuration module 304, a data connection map module 306, a communication module 308, and a storage module 310. Further, in an exemplary embodiment the controller module 302, data configuration module 304, and data connection map module 306 may be implemented by a processor 312.

In an exemplary embodiment, the controller module 302 can be configured to initiate an initial synchronization for the specific or set of data items to create the entry for the FD 102 for the requested data item in the SD 104. Further, the controller module 302 can be configured to connect the FD 102 and maintain a state of the SD 104 with the FD 102.

In an exemplary embodiment, the data configuration module 304 can be configured to receive the data items from the FD 102 for processing the data set and displaying the same to the user. For example, the data configuration module 304 for the contacts data item can prepare the data set including the changed data item fetched from the FD₁ and FD₂. For the email data item, the data configuration module 304 can prepare the data set including the changed email data item from the FD₂ (Refer to FIG. 5E). Similarly, for the gallery data item, the data configuration module 304 can prepare the data set obtained from the FD₁, and FD₂ (refer to FIG. 5C). As it can be seen from the FIG. 5C, it is possible that the SD 104 can have multiple and different FD 102.

In an exemplary embodiment, the data connection map module 306 can be configured to maintain the mapping between the FD 102 and the SD 104 along with their dependent data items. For example, the SD 104 can have two entries for the FD 102 (FD₁, and FD₂) as shown in FIG. 5C. FD₁ can be the data provider for the SD 104 contact data item, email data item, and gallery data item. FD₂ can be the data provider for the SD 104 contact data item and gallery data item. This signifies that from the FD₁, the SD 104 can receive separate data sets for the contact data item, email data item, and gallery data item. From the FD₂, the SD 106 can receive separate data sets for the contact data item, and the gallery data item (Refer to FIG. 5C).

Further, the data connection map module 306 can be configured to receive the request message from the communication module 308 to add the entry for the FD 102 with the data set including the changed data item for which it is to be the data provider. Further, the data connection map module 306 can notify the data configuration module 304 to support data sets from the FD 102 for the requested data items. The data connection map module 306 can verify the metadata associated with the data sets including the changed data item to identify the FD 102 source and data item for which the data set is received. Further, the data connection map module 306 can verify the authorization of the FD 102 for the data item by checking the entries in its map corresponding to the FD 102.

In an exemplary embodiment, the communication module 308 can be configured to receive the data set including changed data item from the FD 102. For example, the communication module 308 in the SD 104 can receive the data sets including the changed data item associated with the FD 102.

In an exemplary embodiment, the storage 310 can be configured to store various data items, data sets, information about FD 102, and the like. The storage 310 can be configured to store control instructions to perform various operation in the system 100.

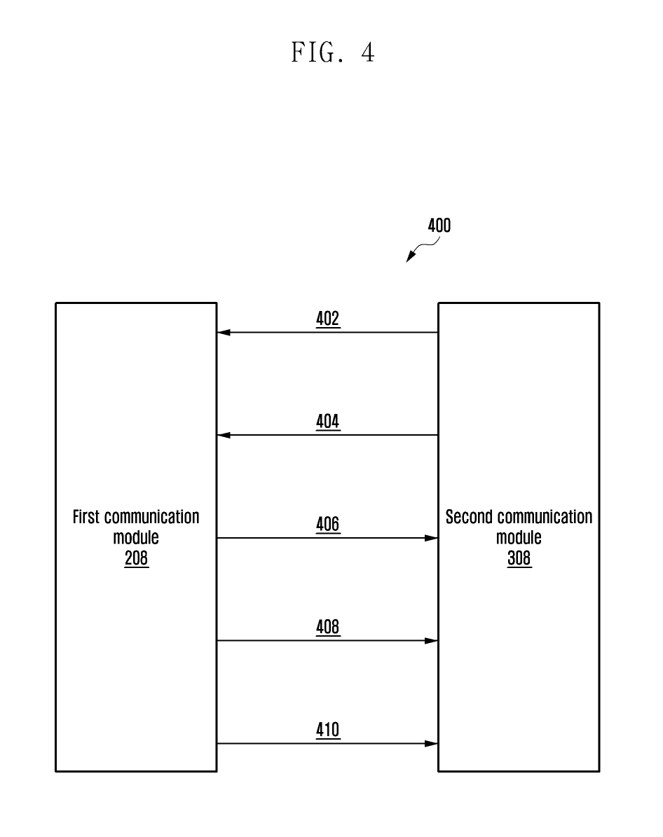

FIG. 4 illustrates various operations 400 performed between the between one or more first devices and one or more second devices, according to an exemplary embodiment. To enable a user to process the same underlying information associated with each data item (e.g., information embodied in specific data items), the information can be synchronized between devices.

In an exemplary embodiment, synchronizing the data items between two different devices can include, for example, initially paring one or more FD 102 with one or more SD 104 and then automatically synchronizing the information associated with the corresponding data items among the devices. At operation 402, the second communication module 308 can initiate a request to initially get paired with the FD 102. For example, the initial synchronization or update operation request can be initiated from either the first device or the second device. At operation 404, the second communication module 308 can configure synchronization preference for some selected data items with the data items of the FD 102. For example, the SD 104 can configure to get synchronization information for the reminder data item and the SNS data item in the FD 102.

At operation 406, the first communication module 208 can be configured to send an acknowledgement message to the SD 106 once it updates all the other modules 200 present in the FD 102 about the new SD 104 pairing and data item synchronization preference. The FD 102 can acknowledge the update request at operation 404. The SD 104 can accept the data items corresponding to the updated data item set from the FD 102 in response to receiving the acknowledgement. The data items can be dropped and considered as invalid until the SD 104 receives the acknowledgement from the FD 102. At operation 408, the first communication module 208 can be configured to initiate the initial synchronization of the selected data items with data item in the SD 104.

Subsequent to the initially pairing and the synchronization, at operation 410, the FD 102 can be configured to identify a change in their data items and dynamically transfer the changed data set to automatically synchronize the changed data item in the FD 102 with the data items of the corresponding paired SD's 104. The synchronization of two data items can include updating one or both of the data items to reflect changes in either of the data items since an initial or previous synchronization.

FIGS. 5A-5F illustrate example system block diagrams for dynamically synchronizing separate data items between one or more first devices and one or more second devices, according to exemplary embodiments. FIG. 5A shows the FD₁ (i.e. smart-phone) paired with the SD₁ (i.e. smart watch) for dynamically synchronizing the data item and the FD₂ (i.e. smart-phone) paired with the SD₁ (i.e. smart watch), and SD₂ (smart watch) for dynamically synchronizing the data items.

FIG. 5B shows the various modules in the FD 102 containing the various data items such as contacts, emails, and gallery data items to be the data provider of SD₁, and SD₂. As shown in FIG. 5B, the FD 102 can be the data provider for the SD₁ and SD₂ for the contact data item and gallery data item. Also, the FD 102 can be the data provider for the SD₁ for the email data item. The list of requested data items along with the SD₁ and SD₂ can be stored in the data connection map module 206 as shown in FIG. 5B. The communicator 208 can create the entry for the SD₁ and SD₂ in the data configuration module 204.

In an exemplary embodiment, the data configuration module 204 can include an ‘Observer’ on a data item database. The observer can receive a call whenever any change is reflected in the data item database. Based on the last synchronization time with respect to each of the SD 104, a query for the updated data can be sent to the data item database to retrieve the data items updated since the last synchronization time. The result of the query may be compared with the contents in the memory table to classify the changes as an insertion type, an update type, a deletion type, or as a combination of changes. The data set for each of the SD 104 can be prepared and thus separate data sets can be created and transferred to each of the SD 104. In the SD 104, the received data set can be queued as per the FD 102. The data is then parsed into the separate data item sets that may be thereafter forwarded to the data item specific parser, which will be responsible of parsing the data, creating appropriate data model, and thereafter inserting it into the database.

Further, the communicator 208 can receive the information about the SD₁ and SD₂ along with the contact data item, the email data item, and the gallery data item from the data configuration module 204. The communicator 208 can communicate with the data connection map module 206 to extract the mapping information of the SD₁ and SD₂, which are mapped with the corresponding data items as shown in FIG. 5B.

FIG. 5C shows various modules in the SD 104, where the multiple data items such as the contact data item, email data item, and gallery data item can be the data receiver of the FD₁, and FD₂. As shown in FIG. 5C, the SD 104 can receive the data set from the FD₁ and FD₂ for the contact data item and gallery data item. Also, the SD 104 can receive the data set from the FD₁ for the contact data item, email data item, and gallery data item. The list of data items to be received from the FD₁ and FD₂ can be stored in the data connection map module 306 as shown in FIG. 5C. The communicator 308 can create the entry for the FD₁ and FD₂ in the data configuration module 304. The communicator 308 can receive the information from the FD₁ and FD₂ along with the contact data item, email data item, and gallery data item from the data configuration module 312 in the SD 104. The communicator 308 can communicate with the data connection map module 306 to extract the mapping information of the FD₁ and FD₂, which are mapped with the corresponding data items as shown in FIG. 5C.

FIG. 5D shows the FD₁ with the separate data sets prepared for the SD₁ and SD₂ individually for the contacts data item. Whenever there is a connection existing between the FD₁ and the SD₁ and between FD₁ and SD₂, then the prepared separate data sets can be sent to the SD₁ and SD₂ individually.

FIG. 5E shows the FD₂ with the data set prepared for the SD₁ for the email data item. Whenever there is a connection between the FD₂ and the SD₁, the prepared data sets can be sent to the SD₁.

FIG. 5F shows a scenario where the connection is available between the FD₁ and the SD₁ and the connection between the FD₁ and the SD₂ is unavailable. Whenever there is a connection between the FD₁ and the SD₁, the prepared contact data set can be sent to the SD₁. If a connection is unavailable as shown in FIG. 5F, the data set can be preserved in the FD₁ and can be sent when the connection between the FD₁ and the SD₂ is available. Otherwise, the data set can be updated to reflect the current contact data item state and can send the updated data set to the SD₂.

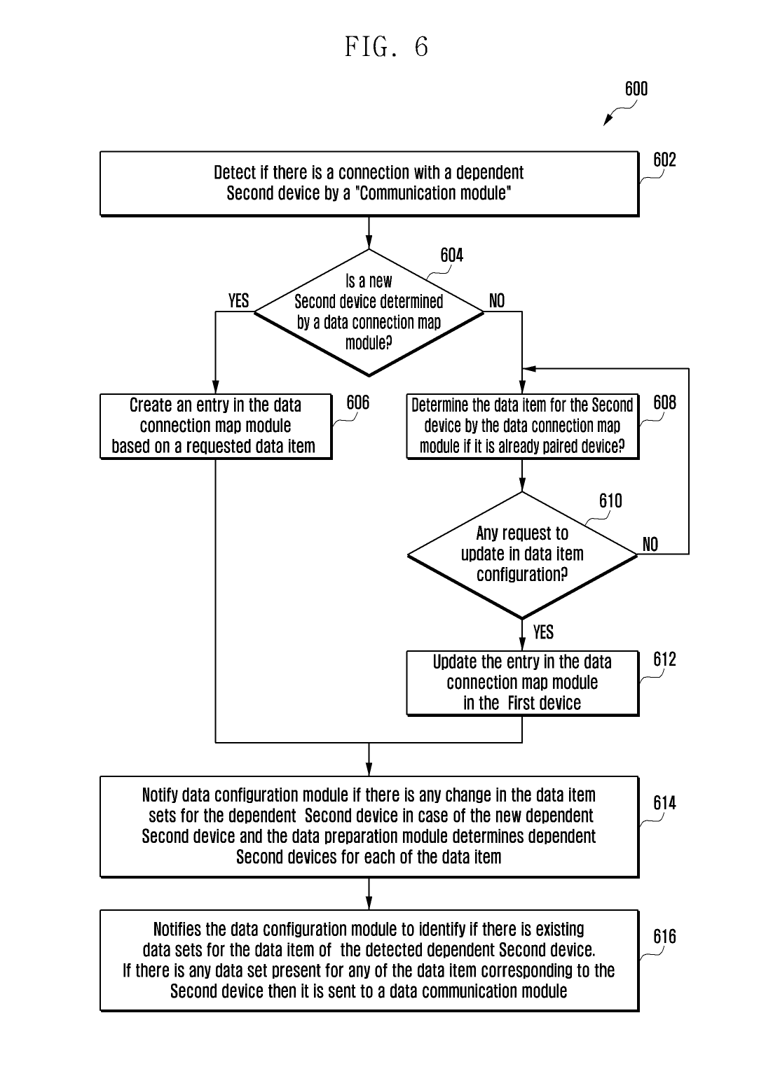

FIG. 6 is a flow diagram illustrating a method 600 for maintaining the correct and consistent state of the SD 104, according to an exemplary embodiment. The method 600 includes, at operation 602, detecting if there is any connection is available between the SD 104 and the FD 102. In particular, the communication module 208 detects the connection availability between the SD 104 and the FD 102. At operation 604, it is determined whether the device is a new SD 104 in response to determining the connection is available between the SD 104 and the FD 102. At operation 606, an entry is created in the data connection map module 206 on the requested data item in response to determining a new SD 104. In particular, the data connection map module 206 creates the entry on the requested data item in the FD 102. At operation 608, the data item for the SD 104 is determined in response to not determining the already paired SD 104. The data connection map module 206 determines the data item for the SD 104 if the SD 104 is the already paired device.

At operation 610, it is determined if any request to update the data item from the SD 104 is received. In particular, the data connection map module 206 determines if any request to update the data item is received. At operation 612, the entry in the FD 102 is updated in response to determining that the request to update the data item is received. The data connection map module 206 updates the entry in the FD 102. At operation 614, the data configuration module 204 is notified if there is any change in the data item sets for the SD 104 in case of a new SD 104. Here, the data configuration module 204 can determine the SD 104 for each of the data items. The data connection map module 206 notifies the data configuration module 204 if there is any change in the data item sets for the SD 104 in case of new SD 104. At operation 616, the data configuration module 204 is notified to identify if there are any existing data sets for the data item of the detected SD 104. If there is any data set present for any of the data items corresponding to the SD 104 then it is sent to a data communication module 208. The data connection map module 206 notifies the data configuration module 204 to identify if there are any existing data sets for the data item of the detected SD 104.

The various actions, acts, blocks, steps, and the like in method 600 may be performed in the order presented, in a different order or simultaneously. Further, in some exemplary embodiments, some actions, acts, blocks, steps, and the like may be omitted, added, modified, skipped, and the like without departing from the scope of the disclosure.

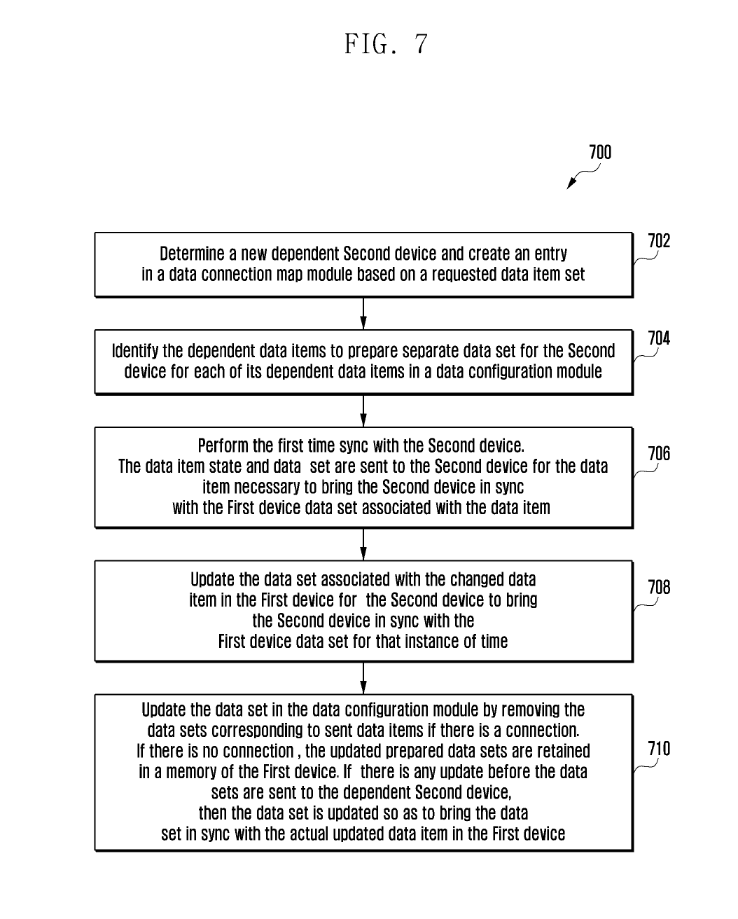

FIG. 7 is a flow diagram illustrating a method 700 for first time synchronization of a data item between one or more first and second devices, according to an exemplary embodiment. At operation 702, the method 700 includes determining a new SD 104 for creating an entry in the data connection map module 206 based on a requested data item set. In particular, the data connection map module 206 determines if the device is the new SD 104. At operation 704, the dependent data items are identified and separate data set can be prepared for the SD 104 for each of the dependent data items in a data configuration module 204. The controller module 202 identifies the dependent data items and prepares separate data set for the SD 104 for each of the dependent data items. At operation 706, the first time synchronization with the SD 104 is performed. The data item state and data set are sent to the SD 104 for the data item necessary to bring the SD 104 in synchronization with the FD 102 data set associated with the data item. The data configuration module 204 performs the first time synchronization with the SD 104 for sending the data item state and data to the SD 104 for the data item necessary to bring the SD 104 in synchronization with the FD 102.

At operation 708, the data set including the changed data item in the FD 102 for the SD 104 is updated to bring the SD 104 in synchronization with the FD 102 data set for that instance of time. At operation 710, the data set in the data configuration module 204 is updated by removing data sets corresponding to the sent data items if the connection is available between the FD 102 and the SD 104. If there is no connection then the updated prepared data sets are retained in a memory of the FD 102. If there is any update before the data sets are sent to the SD 104 then the data set is updated so as to bring the data set in sync with the actual updated data item in the FD 102

The various actions, acts, blocks, steps, and the like in method 700 may be performed in the order presented, in a different order or simultaneously. Further, in some exemplary embodiments, some actions, acts, blocks, steps, and the like may be omitted, added, modified, skipped, and the like without departing from the scope of the disclosure.

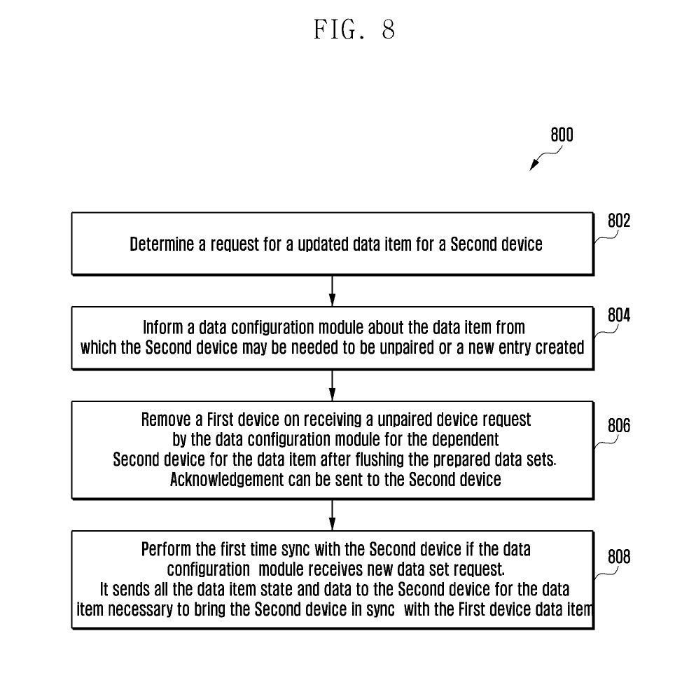

FIG. 8 is a flow diagram illustrating a method for updating data items in response to detecting a change in configuration of a data item associated with an SD, according to an exemplary embodiment. At operation 802, the method 800 includes determining a request for the updated data item for an SD 104. The data connection map module 206 determines the request for the updated data item for the SD 104. Further, the data connection map module 206 updates the data items for the SD 104. Further still, the SD 104 sends a message to update the data set from the FD 102 instantaneously if the connection between the FD 102 and the SD 104 is available; otherwise the message is sent as soon as there is a connection between the FD 102 and the SD 104. Further, the update message may be sent irrespective of the future operations if the update operation consists of the data item associated with the device which is unpaired. For example, even if the SD 104 was unpaired earlier and repaired again before connection could be established, an update operation needs to be sent to the FD 102, which will send acknowledgment message to the SD 104 once the data set is completely removed.

At operation 804, the data configuration module 204 is notified about the data item from which the SD 104 may need to be unpaired or created as a new entry. The data connection map module 206 notifies the data configuration module 204 about the data item from which the SD 104 may need to be unpaired or created as a new entry.

At operation 806, an FD 102 is removed on receiving the unpaired device request by the data configuration module 204 for the SD 104 for the data item after the prepared data sets are deleted. Here, an acknowledgement can be sent to the SD 104. At operation 808, the first time synchronization with the SD 104 is performed if the data configuration module 204 receives a new data set request. It sends all the data item states and data to the SD 104 for the data item necessary to bring the SD 104 in synchronization with the FD 102 data item. The SD 104 may drop all the incoming data sets for the data items corresponding to which it had sent an update message until it receives acknowledgment from the FD 102.

The various actions, acts, blocks, steps, and the like in method 800 may be performed in the order presented, in a different order or simultaneously. Further, in some exemplary embodiments, some actions, acts, blocks, steps, and the like may be omitted, added, modified, skipped, and the like without departing from the scope of the disclosure.

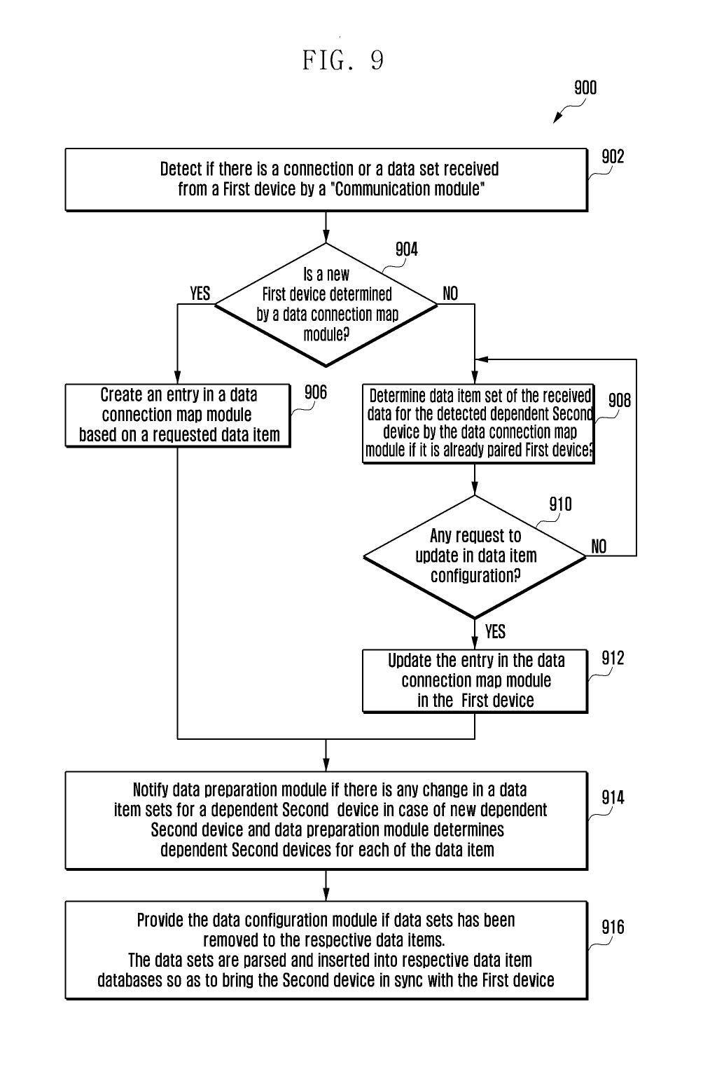

FIG. 9 is a flow diagram illustrating a method for maintaining the correct and consistent state of first device, according to an exemplary embodiment. At operation 902, the method 900 includes detecting if there is any connection or a data set received from an FD 102. The communication module 208 detects the connection availability between the SD 104 and the FD 102. At operation 904, it is determined whether the device is a new FD 102 in response to determining that the connection is available between the SD 104 and the FD 102. The data connection map module 206 determines if the device is the new FD 102. At operation 906, a new entry is created in the data connection map module 206 on the requested data item in response to determining the new FD 102. The data connection map module 206 creates the entry on the requested data item in the SD 104. At operation 908, the data item set of the received data for the FD 102 is determined in response to determining that the device is not the new FD 102. The data connection map module 206 determines the data item set of the received data for the FD 102, if the FD 102 is the already paired device.

At operation 910, it is determined if any request to update the data item for the SD 104 is received. The data connection map module 206 determines if any request to update the data item is received. At operation 912, the entry in the FD 102 is updated in response to determining that the request to update the data item is received. The data connection map module 206 updates the entry in the FD 102. At operation 914, the data configuration module 204 is notified if there is any change in the data item sets for the SD 104 in case of new SD 104. Here, the data configuration module 204 can determine the SD 104 for each of the data item. The data connection map module 206 notifies the data configuration module 204 if there is any change in the data item sets for the SD 104 in case of new SD 104. At operation 916, the data configuration module 204 is provided if the data sets are removed to the respective data items. Further, the data sets are parsed and inserted into respective data item databases so as to bring the SD 104 in sync with the FD 102.

The various actions, acts, blocks, steps, and the like in method 900 may be performed in the order presented, in a different order or simultaneously. Further, in some exemplary embodiments, some actions, acts, blocks, steps, and the like may be omitted, added, modified, skipped, and the like without departing from the scope of the disclosure.

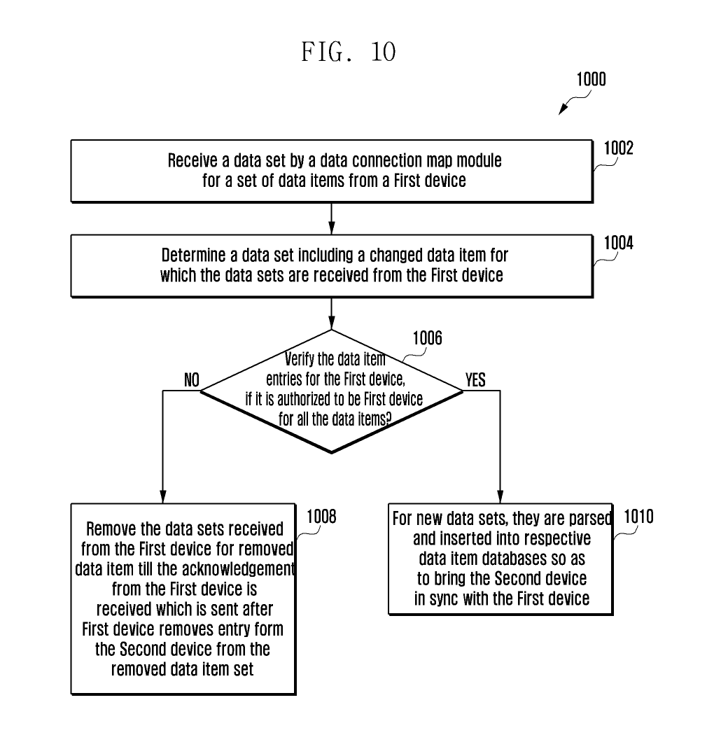

FIG. 10 is a flow diagram illustrating a method for effectively managing data items in the first and second devices, according to an exemplary embodiment. At operation 1002, the data set is received by the data connection map module 306 for the set of data items from the FD 102. The communication module 308 in the SD 104 sends the data set to the data connection map module 306 for the set of data items from the FD 102. At operation 1004, the data sets including the changed data items for the data sets received from the FD 102 are determined. The controller module 302 in the SD 104 determines the data sets including the changed data items for the data sets received from the FD 102. At operation 1006, t the data item entries for the FD 102 are verified if it is authorized to be the FD 102 for all the data items. The controller module 302 in the second device 104 verifies the data item entries for the FD 102 if it is authorized to be the FD 102 for all the data items. At operation 1008, the data sets received from the FD 102 for the removed data item are removed until the acknowledgement from the FD 102 is received, which is sent after the FD 102 removes the entry from the SD 104 for the removed data item. The controller module 302 in the SD 104 removes the data sets received from the FD 102 for the removed data items till the acknowledgement from the FD 102 is received. At operation 1010, new data sets are parsed and inserted into the respective data item databases so as to bring the SD 104 in sync with the FD 102. The controller module 302 in the SD 104 parses and inserts the new data sets into the respective data item databases in the SD 104.

The various actions, acts, blocks, steps, and the like in method 1000 may be performed in the order presented, in a different order or simultaneously. Further, in some exemplary embodiments, some actions, acts, blocks, steps, and the like may be omitted, added, modified, skipped, and the like without departing from the scope of the disclosure.

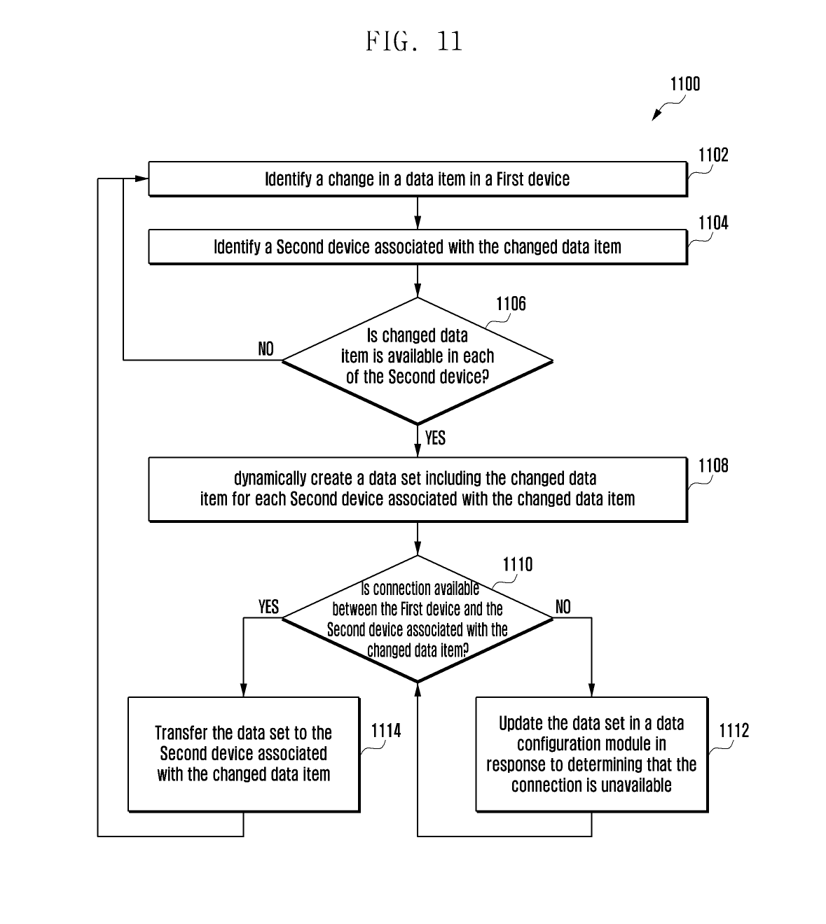

FIG. 11 is a flow diagram illustrating a method for dynamically synchronizing a data item between one or more first devices and one or more second devices, according to an exemplary embodiment as disclosed herein. In an exemplary embodiment, at operation 1102, the method 1100 includes identifying a change in a data item in the FD 102. The data item can be associated with the SD 104. In an exemplary embodiment, the data item can be, for example and not limited to a contact item, a gallery item, a music item, a reminder item, an email item, a social networking site (SNS), and the like. The controller module 202 identifies the change in the data item in the FD 102. At operation 1104, the SD 104 associated with the changed data item is identified. The met controller module 202 identifies the change in the data item in the FD 102. At operation 1106, it is determined whether the changed data item is available in the SD 104. The controller module 202 determines the changed data item is available in the SD 104. At operation 1108, the data set including the changed data item for each SD 104 associated with the changed data item is dynamically created in response to identifying the SD 104 associated with the changed data item. The me data configuration module 204 identifies the SD 104 associated with the changed data item. Further, the data configuration module 204 determines whether the changed data item is available in each SD 104. Further still, the data configuration module 204 dynamically creates the data set including the changed data item for each SD 104 associated with the changed data item. The data set can be created separately for the SD 104 in response to determining that the changed data item is unavailable. Thus, separate data sets can be created by the first device for each of the second devices.

At operation 1110, it is determined whether the connection is available between the FD 102 and the SD 104 associated with the changed data item. The communication module 208 determines whether a connection is available between the FD 102 and the SD 104 associated with the changed data item. At operation 1112, the data set in the data configuration module 210 is updated in response to determining that the connection between the SD 104 and the FD 102 is unavailable. The data configuration module 210 can transfer the data set as it is when the connection is available and dynamically in real time with minimum possible delay from the SD 104. Thus, the second device can receive the updated data sets from the first device prior to receiving any request message from the second device; thereby, saving time and increasing the overall user experience of the system. At operation 1114, the data set is transferred to the SD 104 associated with the changed data item in response to determining that the connection between the FD 102 and the SD 104 is available. The data set including the changed data item can be transferred instantly to the SD 104 prior to receiving the request for synchronization from the SD 104. The communication module 208 transfers the data set to the SD 104 associated with the changed data item in response to determining that the connection between the FD 102 and the SD 104 is available. Further, the communication module 208 transfers the data instantly to the SD 104 prior to receiving the request for synchronization from the SD 104. Thus, the data set including the changed data item in the FD 102 can be transferred instantly to the SD 104 without receiving any request from the SD 104 to receive updated data set including the changed data item.

The various actions, acts, blocks, steps, and the like in method 1100 may be performed in the order presented, in a different order or simultaneously. Further, in some exemplary embodiments, some actions, acts, blocks, steps, and the like may be omitted, added, modified, skipped, and the like without departing from the scope of the disclosure.

In an exemplary embodiment, the sequence of data sets including the changed data items can be dependent on the data priority set by the user for sending the data set to the SD 104; thereby resulting in getting the data set parsed earlier than other data sets in the SD 104 and hence enabling it to be available to the user on the highest priority. During the process of sending the data set to the SD 104, if the priority for the specific data set is received by the user then the data set can be queued in front of all other data sets to be executed at the earliest time. For example, while sending the data set, if an email is received for an urgent meeting, then the email data set must be prioritized compared to other data sets.

In an exemplary embodiment, the data set including the changed data item can be sent to the SD 104 in real time if the connection is available between the FD 102 and the SD 104, otherwise it is sent as soon as the connection is available. Alternatively, in case of a disconnection between the FD 102 and the SD 104, the user can be prompted to be notified about the disconnection. This enables the user to either reschedule the data to be sent at a later time or try continuous re-polling for the connection between the FD 102 and the SD 104. The functionality can be achieved intelligently without the user intervention by predicting the user availability. For example, the user can send the data set after the office hours based on maximum probability of the connection availability between the FD 102 and the SD 104, thereby saving battery and data load and hence facilitating better optimization by speeding up the transfer of the relevant data by reducing CPU wastage.

In an exemplary embodiment, during the first time synchronization each of the SD 104 can notify the FD 102 about the set of data items for which the SD 104 wants to receive the data set including the changed data items. The data sets including the changed data item can be sent explicitly to the SD 104. Alternatively, the capability of the SD 104 can be detected intelligently by the FD 102 based on the type of device, location, usage of the device, and the like. For example, smart glasses may be interested by default only for a camera and map data items but not for the contacts or email data items. This may be detected intelligently by the FD 102 even without receiving any data set with respect to it. For example, when the user is in a market place, it may be desired to share only map data with the smart watch in real time rather than sharing all data, thus saving bandwidth of data sharing, reducing transfer load, battery drain and thereby improving performance. Also, as per the location of the user, the SD 104 and its data item set can be prioritized. For example, when the user is in the market place and needs to navigate through the market, the smart glasses are assigned higher priority compared to smart watch. Moreover for the smart glasses, it may be desired to share only the map data item in real-time rather than sharing all the data items.

In an exemplary embodiment, the data sets and the SD 104 can be assigned with different priorities by the FD 102 based on user preferences. For example, when the user is in an office, priority of the social media data item may be set lower compared to the email data. Also, several data sets can be automatically turned off temporarily as per the situation detected by the FD 102. For example, if the user is in an office location, the social media data sharing may be automatically turned off. This also provides additional security that can be combined with the security layer provided in the FD 102. The different modes can be set explicitly by the user in the FD 102 and the SD 104. Alternatively, these modes may be automatically detected and thereafter different data item sets may be automatically categorized into them. For example, in home mode, data item sets cannot contain official data items that are private to the workplace. Also, as an example, a higher priority can be set for the social media data items. Thus, different data item sets can be active, prioritized, or blocked by the controller module 202 of the FD 102, such as to facilitate optimization of the overall performance and also to ensure security.

In an exemplary embodiment, the data load can be handled by the FD 102 based on several conditions such as battery load, amount of data to be sent, priority or usage of the data, and the like. For example, during a low battery condition, a bulk synchronization process may be suspended such as synchronize with any of the user's cloud account. The process of individual synchronization (sequential slow update of data items in the FD 102), bulk synchronization (importing heavy data at a time in the FD 102) or continuous synchronization (sync with any of the user's cloud account). During continuous synchronization, the data sets are continuously prepared and queued. The data sets are deleted only after successful receipt of data in the SD 104 otherwise the data set is resent. Each data set prepared during the continuous synchronization overrides the data of the previous data sets that has been prepared but not yet sent, and then clears the data set prepared prior to it. These data sets are then tried to be sent to the SD 104 in real time. Alternatively, the data set during continuous synchronization may be scheduled to be sent after each fixed interval of time (for example, 20 seconds). This can be set either by the user or set by the FD 102 based on the system load.

In an exemplary embodiment, whenever there is a change in FD 102, the data set is sent to the SD 104 in real time. Alternatively, the data sets may be configured to be scheduled to be sent after an interval of time. Alternatively, instead of continuous polling of changes for data items in the FD 102, the data preparation module can be configured to check for changes in the underlined database only after certain time intervals. The condition for checking is the last synchronization time. These time intervals may be explicitly set by the user or alternatively detected intelligently by the FD 102 based on the system load. Alternatively, this time interval may be set explicitly in the SD 104 or detected intelligently by the controller module 302 in the SD 104 based on the system load and usage in the SD 104.

In an exemplary embodiment, the data can be configured explicitly by the user to apply a different filter to control the content of data items. For example, a user may select to send only a contact's name and phone number from the FD 102 to a specific SD 104 and all contacts information to other SD 104.

In an exemplary embodiment, the data synchronization can be stopped in between the data sharing between the devices either at the FD 102 or SD 104 explicitly by the user. In that case, the data received in the SD 104 must be saved in its file system to be re-used again. The part of data that had not been sent is retained in the memory of the FD 102 holding the data sets, which will be overwritten with other items if any other updates are observed. This will enable the consistency of the “last synchronization time” and “data set” stored in the FD 102, which will be referred later for data sharing between the devices.

In an exemplary embodiment, the user can set times for on/off times of devices, and set devices as short term devices/long term devices. Short term devices will get only short term data or recent updates only. Long term devices will get full data. Devices can be marked (relation type) as short term, long term, or favorite devices. For example, if the user comes to visit a city, only recent data must be shared to him instead of all data.

In an exemplary embodiment, in the data configuration module 204, data preparation can be done alternatively in a de-centralized environment. For example, smart glasses can maintain data for images/real time shooting/recording data. A calling device can be responsible for making contacts data updates/sharing. When searching is performed in the data item, the search results displayed on the UI of the FD 102 can have an option to share the search result with its SD 104, save it in history of either of the device, or schedule data delivery related to the search result.

In an exemplary embodiment, each data item launcher icons may display the icon status of synchronization with each of the SD 102 in case of FD 102. Similarly, in the SD 104, each launcher icon may display FD 102 icon signifying the FD 102 with respect to that data item.

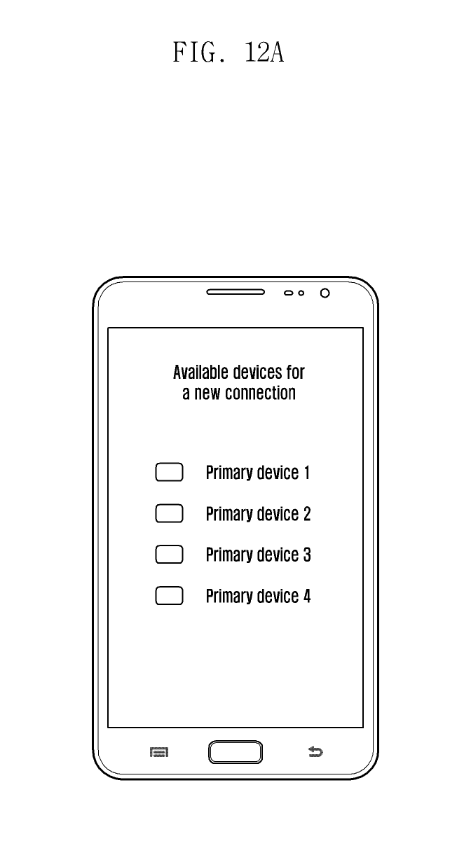

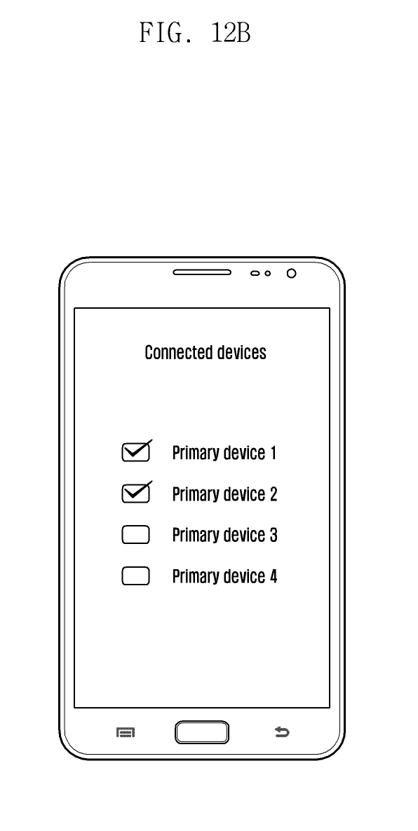

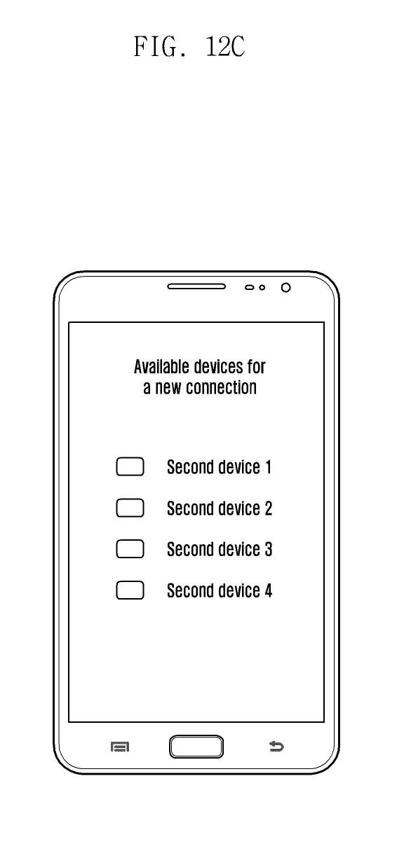

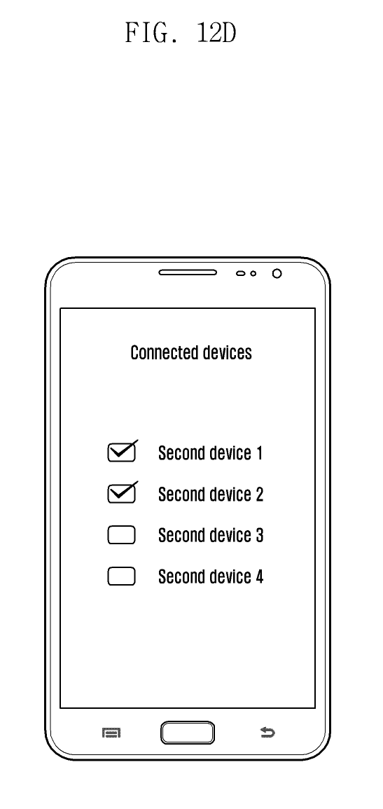

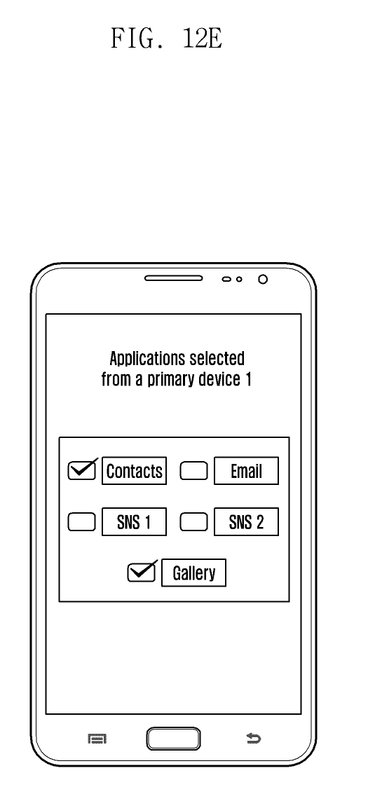

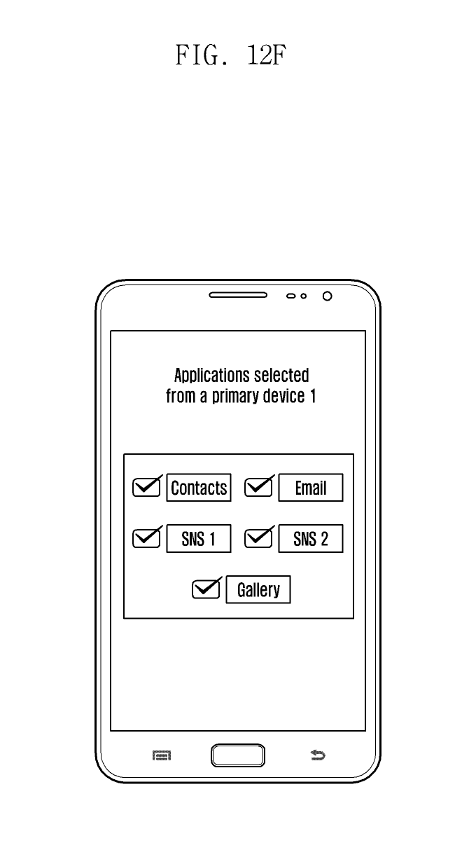

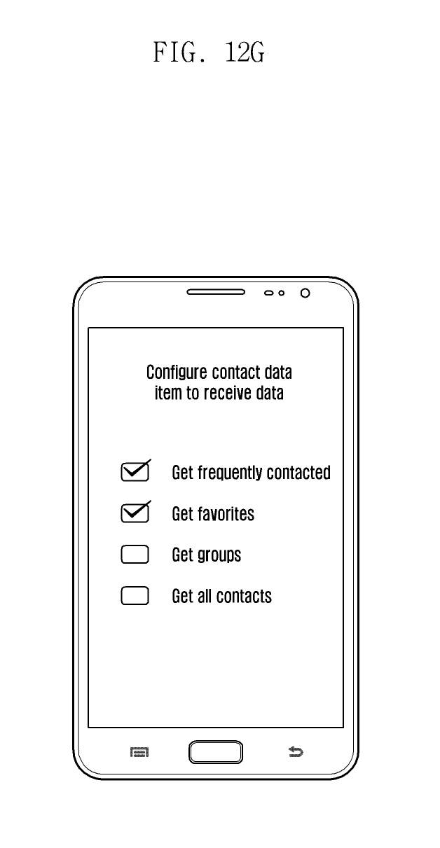

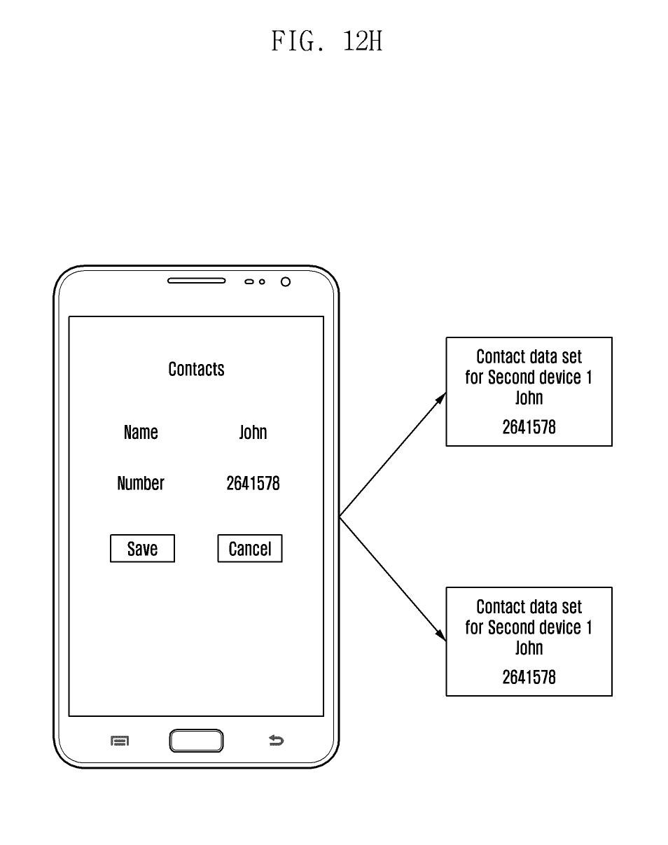

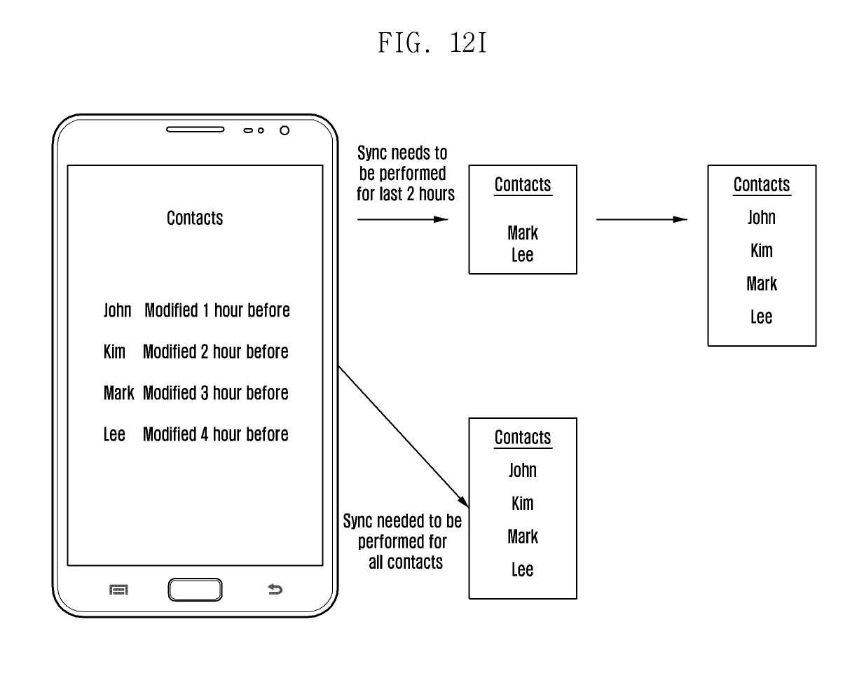

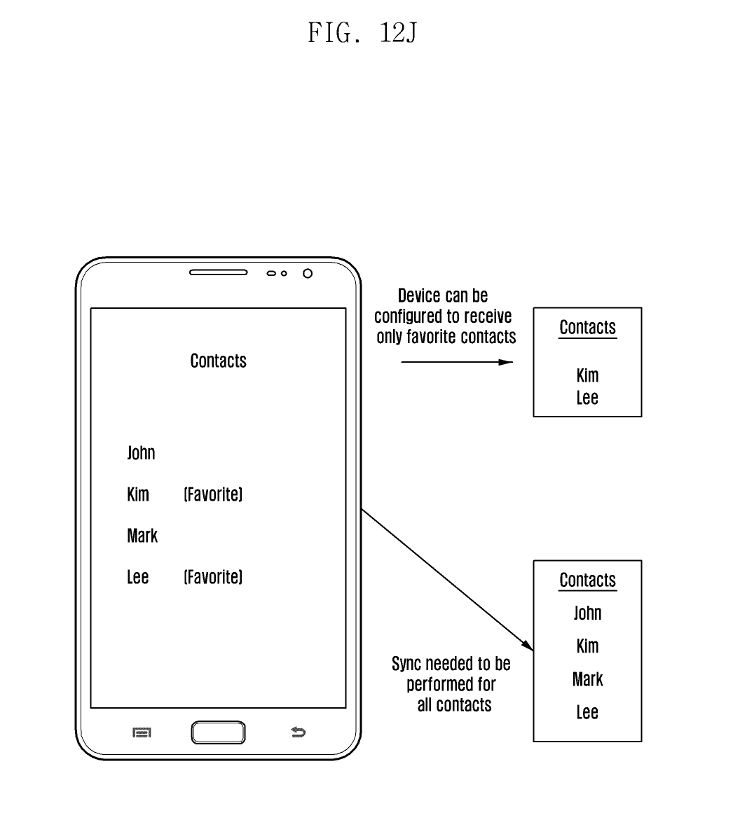

FIGS. 12A through 12J illustrate an example Graphical User Interface (GUI) on a first device or second device for selecting one or more first devices or second devices, and data items, according to exemplary embodiments. In an exemplary embodiment, the GUI can be presented on the either of the FD 102 and SD 104 for devices available for connection that are not presently connected. FIG. 12A shows the 4 FD 102 (i.e. first device 1, first device 2, first device 3, and first device 4) as the GUI on the SD 104 screen. The user can select the first device 1, and first device 2 with which the SD 104 can be in synchronization from the list of available devices as the GUI on the SD 104 screen as shown in FIG. 12B.

FIG. 12C shows the second device 1, second device 2, second device 3, and second device 4 as the GUI on the FD 102 screen. The user can select the second device 1, and second device 2 with which the FD 102 can be in sync from the list of available devices as the GUI on the FD 102 screen as shown in the FIG. 12D.

For the selected first device 1 and first device 2, different sets of data items can be chosen for the purpose of synchronization, as shown in FIG. 12E. For already connected devices, the GUI screen can be presented to pair/un-pair the contact, email, SNS1, SNS2, and gallery data items for synchronization. For each selected first device 1 and first device 2, different sets of data items can be chosen for the purpose of synchronization. Here, the contacts data item and gallery data item can be chosen from the first device 1 and the contact, email, SNS1, SNS2, and gallery data items can be chosen from the first device 2 as shown in FIG. 12E and the FIG. 12F. For an already connected first device and second device, the GUI screen can be presented to pair/un-pair the set of data items for synchronization. For each selected device, different sets of data items can be chosen for the purpose of synchronization.

Each selected data item can be configured for the kind of data the SD 104 wants to receive. In FIG. 12G, contacts data item can display either all of the contacts or any combination of ‘Favorites’, ‘Frequent’ or ‘Group’ type. The user can configure contact data item in the SD 104 to receive updated data set from the FD 102. The user can select “Get frequently contacted” and “Get favorites” data set associated with the changed contact data item as shown in the FIG. 12G.

The contact “John” can be updated by the user with the number “2641578” in the FD 102. The separate data sets containing updated contact of “John” can be prepared for each SD 104 connected to the FD 102 as shown in FIG. 12H. The data set can be updated for all the connected SD 104 in real-time if they are connected without any request/response. If there is a connection, data can be sent directly, otherwise data is stored in the FD 102 to be sent later whenever the connection is available. In FIG. 12I, different set of data items can be sent to different second devices for the change in the first device. The FD 102 can be configured to receive the data set associated with the favorite contacts which were earlier selected by the user as shown in FIG. 12J. The changed data items associated with all the connected second devices can be updated in real time (without any request response).

In an embodiment, the GUI can include various options such as for example, but not limited to, search, data status, relation, history, data selection, type of data control status, type of device status, data progress and the like.

In an embodiment, some scenarios that may not be possible to efficiently handle using related art systems are described. For example consider FD₁ as a first device 102 and SD₁ as a second device 104, where:

1) Both the FD₁ and the SD₁ are new to each other:
a. Both of the devices send first time request to each other
b. The FD₁ updates the “Data connection map module” with the SD₁ state and data
c. The SD₁ updates the “Data connection map module” with the FD₁ state and data
   2) The FD₁ is new to the SD₁ but, the SD₁ is not new to the FD₁:

This can be possible when the following scenario occurs:
a) Pair the FD₁ and the SD₁
b) Un-pair the FD₁ application from the SD₁, when they are not connected. So, the SD₁ can drop all the data sets associated with the FD₁
c) Pair same application in the FD₁ to the SD₁ again so that the SD₁ can create entries for the application again
d) Following can be done after operation ‘c’ when the devices gets connected
   i) In the SD₁, discard any data obtained from the FD₁ for the removed application, until any acknowledgement is received from the FD₁ regarding receiving of ‘Delete data item’
   ii) The SD₁ sends Update application set request to the FD₁, specifying the application for which re-initialization needs to be done in the FD₁
   iii) The FD₁ updates its “Data connection map module” to remove entry for the specified application for the SD₁ entry. “Data Preparation Module” of the FD₁ cleans all the data set associated with the SD₁ in the specified application.
   iv) The FD₁ sends acknowledgement after clean-up is performed for the specified application set in the SD₁
   v) The SD₁ sends initialize request for the same application to the FD₁
   vi) The FD₁ creates entry for the specified application in “Data connection map module”
   vii) The FD₁ sends all the data associated with the specified application to the SD₁ so as to sync the SD₁ to the state of data of data provider application in the FD₁
   viii) Since acknowledgement has already been received, the SD₁ receives data set from the FD₁ parses the data sets and inserts into the database of the application.
      3) The SD₁ is new to the FD₁ but, the FD₁ is not new to the SD₁:

This may be possible when following scenario occurs:
A. Pair the FD₁ and the SD₁
B. Un-pair the SD₁ application from the FD₁ when they are not connected. So, the FD₁ can drop all the data sets associated with the SD₁
C. Pair same application in the SD₁ to the FD₁ again. The FD₁, can create entries for the application again
D. The following can be done after the operation ‘C’ when the devices get connected:
   i. The FD₁ sends Update application set request to the SD₁, specifying the application for which re-initialization needs to be done in the SD₁
   ii. The SD₁ updates the “Data connection map module” to remove the entry for the specified application for the FD₁ entry. The “Data Preparation Module” of the SD₁ cleans all the data set associated with the FD₁ in the specified application
   iii. The SD₁ can send acknowledgement after clean-up is performed for the specified application set in the FD₁
   iv. The FD₁ sends initialize request for the same application to the SD₁
   v. The SD₁ creates entry for the specified application in “Data connection map module”
   vi. The FD₁ sends all the data associated with the specified application to the SD₁ so as to synchronize the SD₁ to the state of the data of data provider application in the FD₁
   vii. The SD₁ receives data set from the FD₁, parses the data sets and inserts into the database of the application.

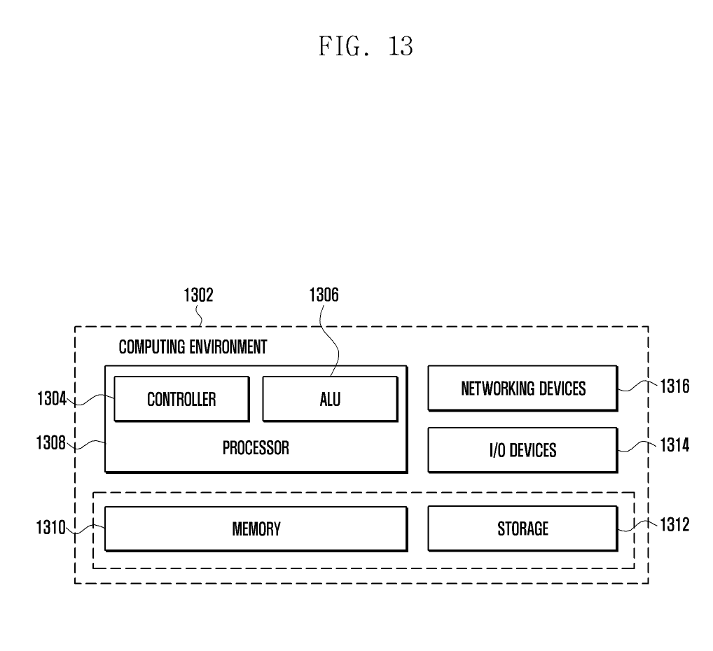

FIG. 13 illustrates a computing environment 1302 of the method and system for dynamically synchronizing a data item between one or more FD and one or more SD, according to an exemplary embodiment. The computing environment 1302 comprises at least one processor 1308 that is equipped with a control unit 1304 and an Arithmetic Logic Unit (ALU) 1306, a memory 1310, a storage 1312, plurality of networking devices 1316 and a plurality Input output (I/O) devices 1314. The processor 1308 is responsible for processing the instructions of the algorithm. The processor 1308 receives commands from the control unit 1304 in order to perform its processing. Further, any logical and arithmetic operations involved in the execution of the instructions are computed with the help of the ALU 1306.

The overall computing environment 1302 can be composed of multiple homogeneous and/or heterogeneous cores, multiple CPUs of different kinds, special media and other accelerators. The processor 1308 is responsible for processing the instructions of the algorithm. Further, a plurality of processors 1308 may be located on a single chip or over multiple chips.

The algorithm comprising of instructions and codes required for the implementation are stored in either the memory 1310 or the storage 1312 or both. At the time of execution, the instructions may be fetched from the corresponding memory 1310 and/or storage 1312, and executed by the processor 1308.

In case of any hardware implementations various networking devices 1316 or external I/O devices 1314 may be connected to the computing environment to support the implementation through the networking unit and the I/O device unit.

The exemplary embodiments disclosed herein can be implemented through at least one software program running on at least one hardware device and performing network management functions to control the elements. The steps, operations, and elements shown in FIGS. 1 through 13 include blocks that can be at least one of a hardware device, software, or a combination of hardware and software.

The foregoing description of exemplary embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of the exemplary embodiments, those skilled in the art will recognize that the embodiments herein can be practiced with modification within the spirit and scope of the embodiments as described herein.

What is claimed is:

1. A method for dynamically synchronizing at least one data item between at least one first device paired with at least one second device, the method comprising:
identifying a change in the at least one data item in the at least one first device, wherein each of the at least one data item is associated with the at least one second device;
creating at least one data set including the at least one data item that is changed for each of the at least one second device associated with the at least one data item that is changed; and
transferring the at least one data set to the at least one second device associated with the at least one data item that is changed prior to receiving a request for synchronization from the at least one second device.

2. The method of claim 1, wherein the transferring the at least one data set to the at least one second device prior to receiving the request for synchronization from the at least one second device comprises:
determining whether a connection is available between the at least one first device and the at least one second device associated with the at least one data item that is changed; and
transferring the at least one data set to the at least one second device associated with the at least one data item that is changed in response to determining that the connection is available, wherein the at least one data set is transferred to the at least one second device prior to receiving the request for synchronization from the at least one second device.

3. The method of claim 1, wherein the transferring the at least one data set to the at least one second device prior to receiving the request for synchronization from the at least one second device comprises:
determining whether a connection is available between the at least one first device and the at least one second device associated with the at least one data item that is changed; and
updating the at least one data set in response to determining that the connection is unavailable, wherein the updated at least one data set is transferred to the at least one second device when the connection is available and prior to receiving the request for synchronization from the at least one second device.

4. The method of claim 1, wherein the creating the at least one data set including the at least one data item that is changed for each of the at least one second device associated with the at least one data item that is changed comprises:
identifying at least one second device associated with the at least one data item that is changed;
determining whether the at least one data item that is changed is available in each of the at least one second device; and
creating the at least one data set including the data item that is changed for each of the at least one second device associated with the at least one data item that is changed, wherein the at least one data set is created separately for the at least one second device in response to determining that the data item that is changed is unavailable.

5. The method of claim 1, further comprising:
receiving the at least one data set in the at least one second device; and
dynamically updating the at least one data item in the at least one second device using the at least one data set to synchronize the at least one second device with at least one first device.

6. The method of claim 1, wherein the at least one data item in the at least one first device to be synchronized with the at least one data item in the at least one second device is determined based on a data item synchronization preference configured by the at least one second device using a graphical user interface.

7. The method of claim 1, wherein the creating the at least one data set further comprises dynamically creating the at least one data set including the at least one data item that is changed without receiving a request for the at least one data item from the at least one second device.

8. A first device for dynamically synchronizing with at least one data item in at least one second device, the first device comprising:
a processor comprising:
a controller module configured to identify a change in the at least one data item in the first device, wherein each of the least one data item is associated with the at least one second device; and
a data configuration module configured to create at least one data set including the at least one data item that is changed for each of the at least one second device associated with the at least one data item that is changed; and
a communicator configured to transfer the at least one data set to the at least one second device associated with the at least one data item that is changed prior to receiving a request for synchronization from the at least one second device.

9. The first device of claim 8, wherein the communicator is configured to transfer the at least one data set to the at least one second device prior to receiving the request for synchronization from the at least one second device by determining whether a connection is available between the first device and the at least one second device associated with the at least one data item that is changed; and to transfer the at least one data set to the at least one second device associated with the at least one data item that is changed in response to determining that the connection is available, wherein the at least one data set is transferred to the at least one second device prior to receiving the request for synchronization from the at least one second device.

10. The first device of claim 8, wherein the communicator is configured to transfer the at least one data set to the at least one second device prior to receiving the request for synchronization from the at least one second device by determining whether a connection is available between the first device and the at least one second device associated with the at least one data item that is changed; and updating the at least one data set in the data configuration module of the processor in response to determining that the connection is unavailable,
wherein the data configuration module is configured to transfer the at least one data set to the at least one second device when the connection is available and prior to receiving the request for synchronization from at the least one second device.

11. The first device of claim 8, wherein the processor further comprises a data connection map module,
wherein the data configuration module is configured to create the at least one data set including the at least one data item that is changed for each second device associated with the at least one data item by identifying the at least one second device associated with the at least one data item that is changed using the data connection map module of the processor; determining whether the at least one data item that is changed is available in each of the at least one second device; and creating the at least one data set including the data item that is changed for each of the least one second device associated with the at least one data item that is changed, wherein the at least one data set is created separately for the at least one second device in response to determining that the at least one changed data item that is changed is unavailable.

12. The first device of claim 8, wherein the communicator is further configured to communicate with the at least one second device, which comprises:
a communicator configured to receive the at least one data set in the at least one second device; and
a processor comprising a data configuration module configured to dynamically update the at least one data item in the at least second device using the at least one data set to synchronize with at the first device.

13. The first device of claim 8, wherein the at least one data item in the first device to be synchronized with the at least one data item in the at least one second device is determined based on a data item synchronization preference configured by the at least one second device using a graphical user interface.

14. The first device of claim 8, wherein the data configuration module is further configured to create the at least one data set further by dynamically creating the at least one data set including the at least one data item that is changed without receiving a request for the at least one data item from the at least one second device.

15. A computer readable medium including a computer executable program code recorded on a computer readable non-transitory storage medium for executing a method for dynamically synchronizing at least one data item between at least one first device paired with at least one second device, the method comprising:
identifying a change in the at least one data item in the at least one first device, wherein each of the least one data item is associated with the at least one second device;
creating at least one data set including the at least one data item that is changed for each of the at least one second device associated with the at least one data item that is changed; and
transferring the at least one data set to the at least one second device associated with the at least one data item that is changed prior to receiving a request for synchronization from the at least one second device.

16. The computer readable medium of claim 15, wherein the transferring the at least one data set to the at least one second device prior to receiving the request for synchronization from the at least one second device comprises:
determining whether a connection is available between the at least one first device and the at least one second device associated with the at least one data item that is changed; and
transferring the at least one data set to the at least one second device associated with the at least one data item that is changed in response to determining that the connection is available, wherein the at least one data set is transferred to the at least one second device prior to receiving the request for synchronization from the at least one second device.

17. The computer readable medium of claim 15, wherein the transferring the at least one data set to the at least one second device prior to receiving the request for synchronization from the at least one second device comprises:
determining whether a connection is available between the at least one first device and the at least one second device associated with the at least one data item that is changed; and
updating the at least one data set in response to determining that the connection is unavailable, wherein the updated at least one data set is transferred to the at least one second device when the connection is available and prior to receiving the request for synchronization from the at least one second device.

18. The computer readable medium of claim 15, wherein the creating the at least one data set including the at least one data item that is changed for each of the at least one second device associated with the at least one data item that is changed comprises:
identifying the at least one second device associated with the at least one data item that is changed;
determining whether the at least one data item that is changed is available in each of the at least one second device; and
creating the at least one data set including the at least one data item that is changed for each of the at least one second device associated with the at least one data item that is changed, wherein the at least one data set is created separately for the at least one second device in response to determining that the at least one data item that is changed is unavailable.

19. The computer readable medium of claim 15, wherein the method further comprises:
receiving the at least one data set in the at least one second device; and
dynamically updating the at least one data item in the at least one second device using the at least one data set to synchronize the at least one second device with at least one first device.

20. The computer readable medium of claim 15, wherein the at least one data item in the at least one first device to be synchronized with the at least one data item in the at least one second device is determined based on a data item synchronization preference configured by the at least one second device using a graphical user interface.
